(19) United States
(12) Patent Application Publication
(10) Pub. No.: US 2003/0102324 A1
(43) Pub. Date: Jun. 5, 2003

(54) Apparatus for dosage of medicaments

(76) Inventor: Miklos Illyes, Budapest (HU)

Correspondence Address: WILLIAM COLLARD, COLLARD & ROE, P.C., 1077 NORTHERN BOULEVARD, ROSLYN, NY, 11576, US

(21) Appl. No.: 10/019,972

(22) PCT Filed: Mar. 7, 2001
(86) PCT No.: PCT/HU01/00028

(30) Foreign Application Priority Data
Mar. 9, 2000 (HU) P 0001103
Feb. 28, 2001 (HU) P 0100911

(51) Int. Cl. G07F 11/66

(52) U.S. Cl. 221/25

(57) ABSTRACT

The subject matter of the invention is an apparatus to dose medicaments and control taking in the medicaments, which apparatus consists of a storage unit (5) to store tablets or capsules, a dosing unit and a counter (7).

The characteristic feature of the apparatus according to invention is that the medicaments (like tablets or capsules) (51) are packed in a medicament tape (50) and stored in the storage unit (5) and cylinders (1) furthering said medicament tape (50) are attached to the storage unit (5) and the said cylinders are mechanically coupled with a manual driving unit (4).

### THE FIELD OF THE INVENTION

An apparatus to dose medicaments and to control taking them, which apparatus consists of a tablet or capsule storage unit, a dosage unit and a counting unit, as well.

### DESCRIPTION OF THE STATE OF ART

Apparatuses serving for dosage medicament tablets or similarly shaped products, like table dosing apparatuses of saccharin or lemon salt are well-known for a long time past. These dosage apparatuses are based on the principle, that a cassette is arranged under a container which holds tablets in bulk mass, and the cassette is movable against a spring force. The cassette is open both on the upper and lower sides. A pill or tablet falls from the container into the cassette. The cassette is moved into the other sector of dosing apparatus, where the bottom of cassette has an opening, the pill or tablet falls out. A treatment of a patient with prescribed medicaments requires an apparatus of higher quality and accuracy. Such apparatus is described in the patent application PCT/US96/0387, which comprises an event counter. The characteristic feature of this apparatus is that a display unit can be cyclically operated in an on and an off status. The counting is coupled with the electric switching on and off the apparatus. The patient carries the apparatus with himself and it counts and records all the events occurring during the treatment. The apparatus has a disadvantage that the dosage of medicament and the counting are not interlocked.

No one of the known apparatuses affords a solution to control, how the patient cooperates with his physician and whether he takes the prescribed medicament in at the prescribed time. If he deviates from the prescription, how long e.g. the deviation time is. Such data are necessary both in the viewpoint of the treatment and for recognition of efficiency of the applied medicament, as well.

It is furthermore necessary, that such data were available in great quantity, in a reliably recorded and well applicable for processing form. Actually no apparatus is known, which is reliable, easy to use and widespread applicable in the physician's practice and medical attendance.

### DESCRIPTION OF THE INVENTION

The destination of this invention is to develop an apparatus for dosage of medicaments, which can be manufactured simply, with low expenses, and its application enables the physician to get knowledge about co-operation of the treated patient, observance of the prescribed cure, by this way the real efficiency of the applied medicament on one hand. On the other hand, the physician's opinion about the medicaments can become more grounded. Another aim of this invention is, to interlock the counting with the effectively dosed medicament units in the apparatus according to this invention.

The invention is based on the recognition, that the tape-shaped package of tablets, pills or capsules in a common blister pack makes it possible to dose the said tablets, pills, or capsules only one by one at any time with simultaneous counting of them, using a simple mechanism and a minimum of electronic equipment. Not only the quantity of dosed medicament units can be recorded by means of an appropriate electronic equipment, but the time of dosage, as well. If the co-operative behaviour (compliance) of patient is associated with the taking the medicament in the prescribed time, the data collected by the apparatus according to invention, deliver information necessary both for medical treatment and for real evaluation of efficiency of the medicament in question.

Another recognition underlying the invention is, that tablets, pills or capsules packed in a tape-shaped common blister pack can be administered simply, hygienically and accurately in a counting and dosing apparatus, which comprises a storage unit containing the medicament in a wound tape, and a dosing one consisting of a tape furthering unit, a shifting one, and, if necessary, a cutting one. We recognised, that the stepwise movement of tape can be performed by the length of one medicament unit at each time even in the simplest embodiment without cutting unit.

A cutting unit becomes automatically wound up at the movement of the shifting unit and it is released at the end of movement by a prescribed length and cuts the tape in another advanced embodiment of the apparatus.

It belongs to the recognitions, that the separate furthering and cutting makes possible a relatively slow furthering followed by an instantaneous cutting. The furthering of the tape and cutting of a medicament unit are, however not simultaneous by this way but one after the other, nevertheless they are bound inseparably together by means of a simple automatic mechanism. It is required that if a furthering has begun, it should not be ceased, but it should be performed anyway on the whole designed length. The movements on partial distances can cause an erroneous positioning of the tape and the cutting can destruct the tablets. We recognised furthermore, that the above mentioned partial movements caused by a partially actuated shifting unit can be eliminated, if the shifting unit rests in the reached position and a following movement can only complete the previous one.

All the embodiments carried out on the base of the above mentioned recognitions can comply with the aim set above, but they have different reliability. It should be considered in any case, whether a simpler, consequently cheaper apparatus or a more exigent, consequently more expensive one should be chosen.

A supplement of the inventive recognitions is, that several advantages can be obtained if an electronic counter, which registers the patient's co-operative behaviour (compliance), is attached to the system as an exchangeable unit. The physician's evaluation becomes easier and the counter becomes reusable even in the case, when the dosing unit used only once and then disposed.

The inventive solution is an apparatus for dosage of medicaments and control of taking in them, the apparatus based on the above mentioned recognitions consists of a storage unit, which stores the capsules or tablets to be dosed, a dosing unit and a counter. The characteristic feature of the solution according to invention is that furthering cylinders are mounted onto the container which stores the medicament units (either tablets or capsules, packed into a tape shaped blister pack), and the said cylinders are mechanically coupled with a hand operated driver unit.

The apparatus according to invention can be advantageously characterised by that it is equipped with a cutting unit, which serves to disjoint one by one the segments of the tape containing medicament units.

Another advantageous feature of the apparatus is that the counter comprises a mechanic signal transmitter, an electronic sensor, an internal clock and a memory unit.

A further advantageous feature of the apparatus according to invention is that the driver unit is coupled with the signal transmitter, which transmits a signal to the sensor at each dosing of medicament units. The coupling can be a direct or an indirect one, it can be established e.g. either by the shifting unit and/or by the axle. The apparatus according to invention can be advantageously characterised by that the driving unit is mechanically coupled with a cutting unit and actuates it.

A following advantageous feature of the apparatus according to invention is that the driving unit is coupled with the cylinders through a stepping mechanism equipped with a position stabiliser and an inhibitor unit.

The embodiment with inhibitor unit can be advantageously characterised that the stepping unit is equipped with lifting units, which lift the stepping one to an ineffective position and releasing ones which eliminate the lifting.

A further advantageous embodiment of the apparatus according to invention can be characterised that one of the cylinders is equipped with a unit winding up the cutting unit, namely with a cutting gearwheel, and with a unit releasing it i.e. initiating the cut namely a cylinder lifting unit.

Finally, the apparatus according to invention can be advantageously characterised that the counter is exchangeable by its shape and dimensions, and it is mounted onto apparatus using a known in itself solution and can be simply inserted, taken out or changed.

The invention is shown by means of the attached drawings without any limitation of the extent of protection claimed and the possible embodiments of the invention to the shown embodiments.

The figures:

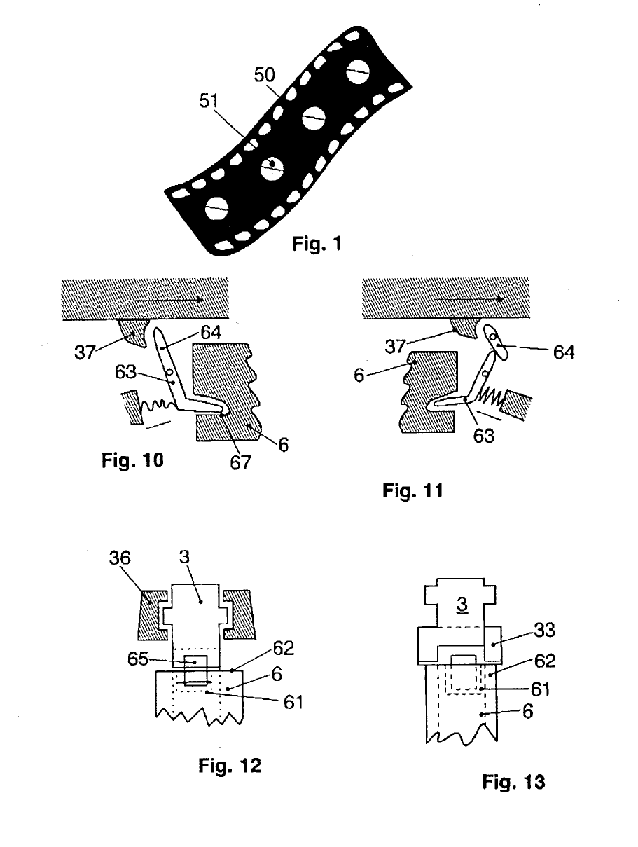

FIG. 1: View of the tape shaped blister pack of medicament.

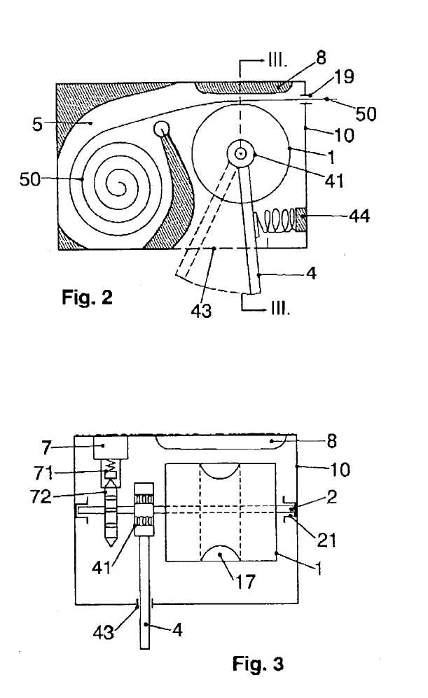

FIG. 2: Simplified side view with section of the apparatus according to invention

FIG. 3: Simplified section of the apparatus shown in the FIG. 2 according the III-III plane

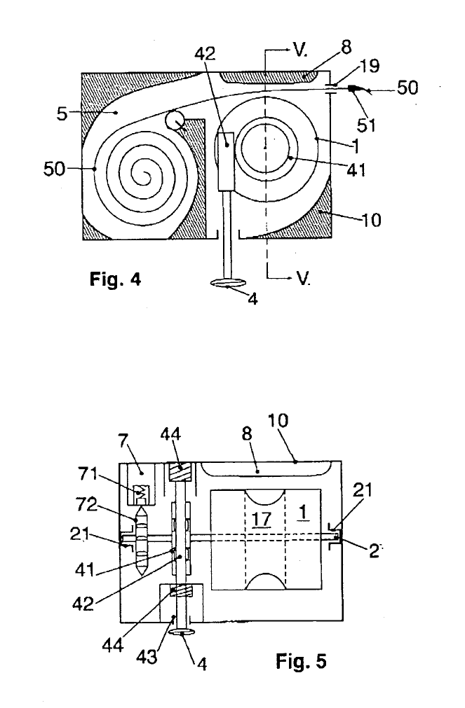

FIG. 4: Simplified side view with section of another advantageous embodiment of the apparatus according to invention

FIG. 5. Simplified section of the apparatus shown in the FIG. 4 according to V-V plane

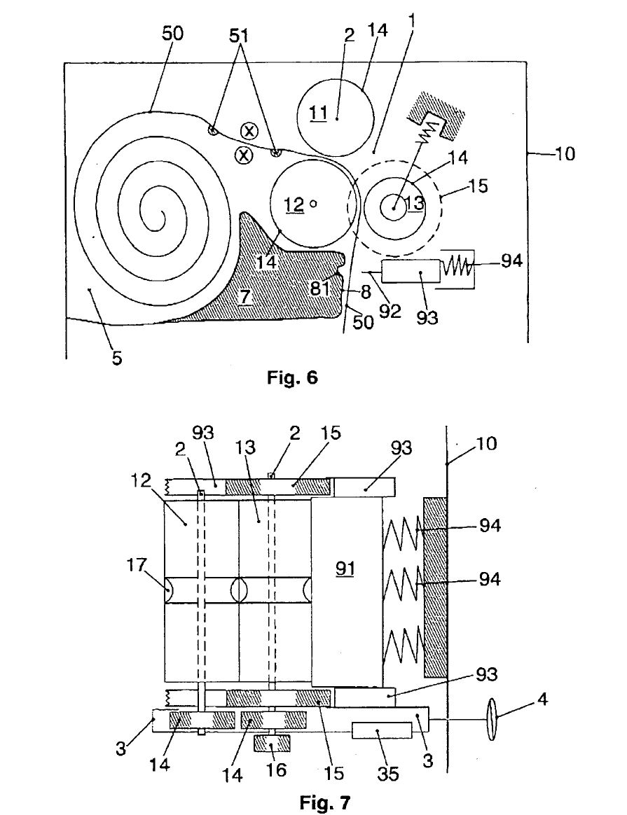

FIG. 6: Simplified side view of the embodiment of the apparatus according to invention with cutting unit

FIG. 7: Simplified section by horizontal plane of the apparatus shown in FIG. 6

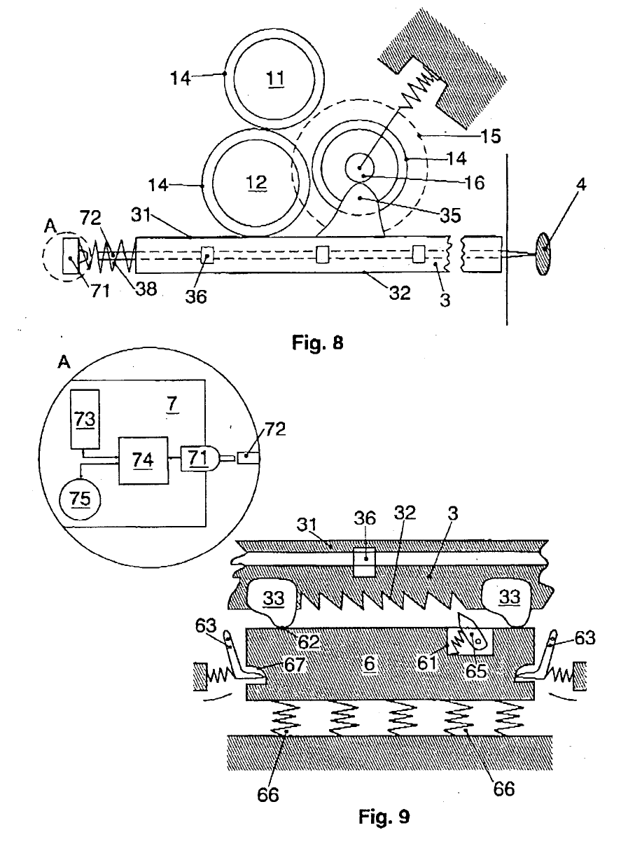

FIG. 8: Section of the stepping unit of the embodiment shown in FIG. 6

FIG. 9: Coupling of the stepping and inhibitor unit in the embodiment shown in FIG. 6

FIG. 10: Detail drawings in section of the fastening and releasing units of the inhibitor unit.

FIG. 11: Detail drawings in section of the fastening and releasing units of the inhibitor unit with other arrangement.

FIG. 12: Detail drawing showing the guide of stepping unit and the inhibitor unit in section

FIG. 13: Detail drawing showing the lifting unit of the arresting one in section

According to the invention the tablets 51 which can be any medicament units i.e. tablets, pills or capsules are packed into a blister pack tape 50 arranged equidistantly in one row along the length of tape (FIG. 1). The tape can be made of any known in itself foil or synthetic film. The medicament tape 50 consists of two layers and the tablets are arranged between the layers as mentioned above. One of borders or both borders of the medicament tape 50 can be provided with a guiding row of holes similarly to film-strips or computer printer paper for a feeding mechanism with sprocket wheel, if necessary. It is sufficient even the antiskid treatment of the borders to further the tape. The medicament tape is provided advantageously with perforation or weakened at the section in the half distance between the tablets. The apparatus according to the invention is mounted into housing 10. A part of this housing is the storage unit 5. (FIG. 2). The medicament tape 50 is housed in it in wound up state. In the other part of housing 10 is mounted a cylinder 1 fastened on an axle 2. The axle 2 is mounted in bearings 21 shaped in the housing 10 and it can be rotated. An arm shaped driving handle is coupled with the axle through a ratchet motion 41 (FIG. 3). The driving handle 4 projects out of the housing 10 through an opening 43. The dimensions of the opening enables the driving handle to turn by an angle that the curved surface of cylinder 1 moves the medicament tape further by the length of one tablet.

The driving handle 4 is coupled with a basic spring 44, its other end is fastened to the housing 10. A guiding element 8 is arranged above the cylinder 1 which can be substituted by a row of rolls. The free end of the medicament tape 50 stored in the storage unit 5 goes between the cylinder 1 and the guiding element 8 to the outlet opening 19 in the wall of the housing 10. The curved surface of the cylinder 1 can be even or provided with pins for a medicament tape 50 with guiding holes or the cylinder 1 can be substituted with a combination of cylinder with sprocket-wheels. The cylinder 1 has a groove 17 which lets the tablets go through. A signal transmitter 72 is fastened onto the axle 2, too. The signal transmitter 72 is a disc with cams on its circumference The cams are arranged evenly, their number is equal to that of tablets 51 being in the part of medicament tape 50 which covers the perimeter of cylinder 1. A sensor 71 is fastened against the signal transmitter 72, which issues an electric output signal under pressure. The counter 7 includes furthermore an evaluating unit 74, an internal clock connected to it, and a memory unit 75 connected to the evaluating unit. All the electronic units are known in themselves commercial products, and they are assembled by ordinary way, as well. A further simple embodiment of the apparatus according to invention deviates from the above described one, that an annular gear is shaped on the perimeter of the ratchet motion 41 and the driving handle 4 is a gear rack 42 mounted vertically in relation to the axle 2 (FIGS. 4 and 5). The driving handle projects out of the housing 10 through the opening 43 and it is mounted so that it can be moved only “vertically”, i.e. perpendicularly to the plain of the opening 43. The gear rack 42 is engaged with the annular gear of the ratchet motion 41. The movement of the driving handle is limited by stops to a span, which corresponds to a pivot of cylinder 1 to further a tablet 51. The movement of driving handle 4 is performed against force of at least one basic spring 44 which is released when the driving handle 4 projects out of the housing 10 and is wound up when the said handle is pushed in. Advantageously the apparatus can be equipped with a manual cutting unit (not shown for simplicity). The latter is mounted onto the housing 10 next to the outlet opening 19. It can be e.g. a blade guided by rail or turning around a pivot and actuated by hand in both cases. The cutting unit is positioned so that it cuts in the middle of distance between two tablets. A more advanced version of the apparatus according to invention includes an automatic cutting unit 9. The driving handle 4 is coupled to the cylinders 1 through a stepping unit 3 and at least one of said cylinders 1 is coupled to the cutting unit 9. The subassembly, which furthers the medicament tape 50 consists of three cylinders 1 (see FIG. 6) the axles thereof are arranged like lateral edges of a prism of triangular basis. All the cylinders are provided with groove 17 in the middle of their curved surfaces. The locations of cylinders are different. A driven cylinder 12 is installed advantageously next to the storage unit. The driven cylinder 12 is coupled with the pressing cylinder 11 on one hand and with the cutting cylinder 13 on the other hand. Gear wheels 14 are mounted on the axles of each cylinder in one plain, they establish the coupling between them. (see FIG. 7) There are cutting gear wheels 15 mounted on the both ends of the cutting cylinder 13 nearer to the cylinder as the coupling gearwheel 14. Their diameters are greater than those of gear wheels 14 and they can be arranged because a gap exists wider than said wheel 15 between the driven cylinder 12 and its coupling gear wheel 14. A stepping unit 3 is coupled to the gear wheel 14 of the driven cylinder 12 (see FIG. 8). It is a rod of square profile, coupled to the gear wheel 14 of the driven cylinder 12 through a gear rack 31. The stepping unit 3 is guided through coupled ribs and grooves in a guiding element 36 arranged on both longitudinal sides of the stepping unit 3 (see FIG. 12) The stepping unit 3 is coupled to the opposite wall of apparatus by a stepping spring 38, where a mechanic sensing button 71 of an electronic counter 7 is fastened. A breaking edge 32 is shaped on the opposite (lower) side of the stepping unit to the gear rack 31. The breaking edge 32 is provided with triangular teeth and it is coupled to an inhibitor unit 6 (see FIG. 9). The inhibitor unit 6 includes a ratchet-closing device 61, the tongue 65 thereof is stressed to the triangular teeth of the braking edge 32. There are lifting shoulders 62 on both sides of the inhibitor unit 6 (see FIG. 13), their height together with the lifting arms 33 is greater than the penetration depth of the tongue 65 i.e. the depth of teeth on the braking edge 32. The inhibitor unit 6 is equipped with fixing clips 63 (see FIGS. 10, 11) which are mounted onto pins and they are turnable under spring pressure around the pins and they engage into cavities 67 on both frontal ends of the inhibitor unit 6. The stepping unit is equipped with at least two clip releasing units 37 which contact with the advantageously extended ends of the fixing clips 63 on the opposite side of the said pin in the basic position of the stepping unit 3. A cutting unit 9 including two toothed racks 93 which hold a knife 91 on its both sides and they are pressed by a cutting spring 94 towards the storage unit 5 (see FIG. 7). The axle 2 of the cutting cylinder 13 is supported by bearings with springs and a roll 16 is fastened on its end. A cylinder lifter 35 extends from the stepping unit 3 to the said roll 16. The surface of the wall of storage unit 5 is shaped as guiding surface 8 under the cylinders 1 on the side facing to the knife 91 and it is provided with a cutting groove 81 parallel to the axles 2.

The counter 7 is advantageously fitted into a compartment corresponding to its shape and dimensions, with an inner opening to the signal transmitter and being accessible from the outer side of the housing 10. The counter 7 is fastened into the said compartment by clamp joint or any other releasable fastening known in itself.

The apparatus functions and it can be used by the following way. First the physician determines the cure and the medicament. He loads then the medicament in the form of medicament tape 50 into the storage unit 5 and leads the free end of the tape between the cylinders 1 or between a cylinder and a guiding surface 8. He closes the housing 10 with a seal. If a simple embodiment shown in FIGS. 2 to 4 is used, the patient either moves the driving handle as the opening 43 lets it to move (see FIGS. 2, 3) or pushes it inwards until it stops (see FIGS. 4,5) He turns the cylinder 1 by an angle, that it moves the medicament tape forward by the length of a tablet sector 51. He tears off the part of the medicament tape 50 containing a tablet 51 run out at the perforation, or he cuts it off, if the apparatus is equipped with a cutting instrument. The signal transmitter 72 issues a signal to the sensor 72 at the dispensing of each tablet, and an electronic signal enters the evaluating unit 74 from the said sensor. The evaluating unit calls the actual time from internal clock 73 and records both the event of dispensing and the incidental time in the memory unit 75. The I/O connection of the counter 7 enables to call the data for processing. This embodiment can properly function only if it is properly used. The driving handle should be moved along the whole allowed path and the moved segment should be cut off at each time.

In another advanced embodiment the stepping unit 3 is moved forward by pushing down the driving handle 4. The gear rack 31 is engaged with the gear wheel 14 of the driven cylinder 12. The driven cylinder 12 moves the medicament tape 50 forward exactly by a length of a section containing one tablet 51 at one whole movement of the stepping unit 3, as result of properly determined dimensions. If a pushing cylinder 11 is applied above the driven cylinder 12, a pair of gear wheels ensure the synchronised rotation of cylinders 1. A medicament tape 50 with leading row of holes is moved forward by means of pins on the cylinders 1 or sprocket wheels mounted on the sides of said cylinders 1. The tablets 51 pass through groove or grooves in the one or more cylinders 1 applied, this way they are not damaged by passing the cylinders 1. The free end of medicament tape 50 is lead between the driven cylinder 12 and the cutting cylinder 13 and then it reaches the guiding surface 8. At the start the medicament tape should be positioned so that the beginning of the section containing the first tablet 51 be exactly at the cutting groove 81. The medicament tape moves forward by a section of medicament tape 50 containing one tablet 51, and the line between two tablets 51 steps to the cutting groove 81 at each actuation of the driving handle 4 after this positioning. The cutting unit 9 functions as follows: While the driven cylinder 12 moves, it turns the cutting cylinder 13 through gear wheels 14. The cutting cylinder moves the toothed racks 93, at the same time the complete cutting unit 9 in the direction opposite with the movement of stepping unit compressing the cutting springs 94 and accumulating energy in them Before the stepping unit reaches its final position, the cylinder lifting arm 35 fastened on it reaches the roll 16 on the end of axle 2 of the cutting cylinder 13 (FIG. 7). and detaches the cutting gear wheel 15 from the gear rack 93. The energy of cutting springs 94 pushes forward the cutting unit 9 so that the knife 91 lashes into the cutting groove 81 and cuts off a tablet 51 from the medicament tape 50. The tablet 51 falls into a dispensing nest. The stepping unit 3 reaches its final position and issues a signal to the counter 7 by pushing the sensor 71 (FIG. 8). When the driving handle is released, the stepping spring 38 pushes back the stepping unit 3 and the driving handle 4 into their basic positions. The cylinder lifting arm 35 moves backwards and it does not lift the cutting cylinder any more, the cutting gear wheel 15 and gear rack 93 are re-engaged. When the driving handle 4 is pushed down again, the cutting unit 9 becomes wound up again. This apparatus works reliably, if the user operates it accurately, and he pushes the driving handle 4 always up to stop i.e. until the cutting unit 9 is released and lashes into the cuffing groove 81. If he does not take care of it he pushes down the driving handle 4 only partially, then releases it and tries to push once more, the medicament tape 50 gets into wrong position and the cutting edge 92 may touch a tablet 51.

The partial movement of the driving handle 4 is inhibited in a further advantageous embodiment The inhibitor unit 6 functions as follows: The backward movement of the stepping unit 3 caused by the stepping spring 38 is inhibited by the catch device 61 of the inhibitor unit 6, the tongue 65 thereof catches the teeth of the breaking edge 32 on the lower part of stepping unit 3. If the patient does not push the driving handle 4 and the stepping unit 3 down up to the stop, the later is fixed in the position of partial movement (see FIG. 9). This state remains up to the moment, when the lifting arms 33 of the stepping unit 3 reach the lifting shoulders 62 on the sides of inhibitor unit 6 (see FIG. 13). At the moment of contact the braking edge 32 and the catch device 61 are detached The inhibitor unit 6 is pushed down against the inhibitor springs 66 and the fixing clips 63 enter into cavities 67 on its sides, as the inhibitor unit 6 reaches their height (FIGS. 10 and 11). These fixing clips 63 fasten the inhibitor unit 6 independently from the lifting arms 33. Being detached from the inhibitor unit 6 the stepping unit 3 returns into its basic position under force of stepping spring 38. The clip releasing units 37 engage with the fixation releasing elements 64 and the fixing clips step out of the cavities 67. The inhibitor unit 6 re-engages with the stepping unit 3. Consequently, there is a cyclic procedure in the actuation of the apparatus. When the stepping unit 3 is moved partially forward, the inhibitor unit 6 prevents its movement backwards until the stepping unit reaches its desired final position. In this moment the effect of the inhibitor unit 6 terminates, the stepping unit 3 returns to its basic position, and the inhibitor unit 7 returns into basic position at the same time, as well, and re-enters its effect. The counter 7 works by the same way as described above.

At the end of treatment the counter 7 is taken out of the housing 10, connected to the physician's computer and its data content is evaluated. Having deleted the data content, the counter 7 can be re-inserted into a housing 10 reloaded with a new dose of medicament or, if the apparatus is designed for single usage, the counter 7 can be used for a new apparatus.

The apparatus according to invention is a new combination built up of mechanic and electronic elements known in themselves. It fulfils important medical and health care requirements: it informs the attending physician, whether the prescribed cure was performed according to prescriptions, and the planned medical effect was reached at the actual patient at one hand. On the other hand, it provides reliable data for the statistical evaluation of the efficiency of medicaments eliminating all the doubts originating from the deficit of knowledge of patients. All the energy consuming elements of the apparatus are mechanical structures, which are driven by hand of patient. The energy requirement of the electronic part is very low, so it can be reliably used for long time. The applied package of the medicament is also advantageous because the whole quantity of medicament necessary for the cure is loaded in a hygienic package by the physician into the dosing apparatus.

1. An apparatus for dosing medicaments serving to control the taking in prescribed medicaments, which apparatus consists of a storage unit, which stores the tablets or capsules to be dosed, a dosing unit and a counting one, characterised by that medicament units (51) (either capsules or tablets) packed in a medicament tape (50) are stored in a storage unit (5) and cylinders (1) furthering said medicament tape (50) are attached to the storage unit (5) and the said cylinders are mechanically coupled with a manual driving unit (4).

2. The apparatus according to claim 1, characterised by that the apparatus is equipped with a cutting unit which serves to cut off a segment of the medicament tape (50).

3. The apparatus according to the claims 1 or 2, characterised by that a counter (7) is attached to the apparatus, which comprises a mechanic signal transmitter (72), an electronic sensor (71), an electronic evaluating unit (74) electrically connected to said sensor, an internal clock (73) and a memory unit (75).

4. The apparatus according to claim 3, characterised by that the driving unit (4) is coupled with the signal transmitter (72) issuing a signal to the sensor (71) at dosing of each tablet.

5. The apparatus according to any one of the claims 1 to 4 characterised by that the driving unit (4) is coupled with a cutting unit (9) in a manner to control the latter, which corresponds to the above mentioned cutting unit.

6. The apparatus according to any one of the claims 1 to 5 characterised by that the driving unit (4) is coupled with the cylinders (1) through a stepping unit (3) equipped with an inhibitor unit (6) stabilising the position.

7. The apparatus according to claim 6 characterised by that the stepping unit (3) is equipped with lifting arms (33) which lift the inhibitor unit into an ineffective position and whit releasing arms (37) which eliminate the lifting.

8. The apparatus according to any one of the claims 1 to 7 characterised by that at least one of the cylinders (1) is equipped with an unit winding up the cutting unit (9), namely with a cutting gear wheel (15) and the stepping unit (3) is equipped with a unit eliminating the winding up of the cutting unit (9), namely a cylinder lifter (35).

9. The apparatus according to any one of the claims 3 to 8 characterised by that the counter (7) is built up and fastened in the apparatus as an exchangeable unit.
